(19) United States
(12) Patent Application Publication
(10) Pub. No.: US 2006/0098154 A1
(43) Pub. Date: May 11, 2006

(54) Method of manufacturing flexible display device

(76) Inventors: Sang-Il Kim, Suwon-si (KR); Wang-Su Hong, Suwon-si (KR); Woo-Jae Lee, Yongin-si (KR)

Correspondence Address: CANTOR COLBURN, LLP, 55 GRIFFIN ROAD SOUTH, BLOOMFIELD, CT, 06002, US

(21) Appl. No.: 11/225,745

(22) Filed: Sep. 13, 2005

(30) Foreign Application Priority Data
Nov. 9, 2004 (KR) 10-2004-0090904

(51) Int. Cl. G02F 1/13

(52) U.S. Cl. 349/187

(57) ABSTRACT

A method of manufacturing a flexible display device includes adhering a first substrate to a supporter, half cutting the first substrate to divide the first substrate into a first region and a second region, assembling the first substrate and a second substrate facing the first substrate, combining the first and second substrates, and removing the second region of the first substrate from the first region of the first substrate.

This application claims priority to Korean Patent Application No. 2004-0090904 filed on Nov. 9, 2004 and all the benefits accruing therefrom under 35 U.S.C §119, and the contents of which in its entirety are herein incorporated by reference.

### BACKGROUND OF THE INVENTION

(a) Field of the Invention

The present invention relates to a method of manufacturing a flexible display device, and more particularly, to a method of manufacturing a flexible display device including a plastic substrate.

(b) Description of the Related Art

A liquid crystal display (LCD) device and an organic light emitting display (OLED) device are examples of widely used flat panel display devices.

An LCD device includes two panels provided with field-generating electrodes such as pixel electrodes and a common electrode and polarizers. The LCD device further includes a liquid crystal (LC) layer interposed between the two panels. The LCD device displays images by applying voltages to the field-generating electrodes to generate an electric field in the LC layer, which determines orientations of LC molecules in the LC layer to adjust polarization of incident light.

An organic light emitting display (OLED) is a self emissive display device, which displays images by exciting an emissive organic material to emit light. The OLED includes an anode (hole injection electrode), a cathode (electron injection electrode), and an organic light emission layer interposed between the anode and the cathode. When holes and electrons are injected into the light emission layer, the holes and electrons recombine and pair annihilate to emit light.

However, because the LCD device and the OLED device include fragile and heavy glass substrates, OLED and LCD devices are not suitable to portability and large scale display construction.

Accordingly, a display device using a flexible substrate such as a plastic substrate that is both light and strong has recently been developed.

In comparison to the glass substrate, the plastic substrate has many merits that include, for example, portability, stability and low weight. Furthermore, use of the plastic substrate allows a deposition process and a printing process to be used to form a flexile display, and the flexible display using the plastic substrate may be manufactured by a roll-to-roll process different from a general sheet unit process. Accordingly, production costs may be minimized due to a capability to produce a large quantity and/or size of flexible display devices.

However, the general cutting method used in manufacturing a display device including the glass substrate cannot be adapted to manufacturing the flexible display using the plastic substrate.

### SUMMARY OF THE INVENTION

A method of manufacturing a flexible display device is provided, which includes adhering a first substrate to a supporter half cutting the first substrate to divide the first substrate into a first region and a second region, assembling the first substrate and a second substrate facing the first substrate combining the first and second substrates, and removing the second region of the first substrate from the first region of the first substrate.

Another exemplary method of manufacturing a flexible display device includes adhering a first substrate to a supporter, cutting through an entire thickness of the first substrate at selected portions of the first substrate defining an active region of the flexible display and not cutting through any part of the supporter, combining the first and second substrates, and removing the supporter and portions of the first substrate not including the active region.

### BRIEF DESCRIPTION OF THE DRAWINGS

The above and other advantages of the present invention will become more apparent by describing exemplary embodiments thereof in detail with reference to the accompanying drawings in which:

FIG. 1 is a layout view of a thin film transistor (TFT) array panel for a liquid crystal display (LCD) device according to an exemplary embodiment of the present invention;

FIG. 2 is a sectional view of the LCD device including the TFT array panel shown in FIG. 1 taken along line II-II′;

FIGS. 3 to 8 are sectional views of a color filter panel for the LCD device in FIG. 2 in intermediate steps of a manufacturing method thereof according to an exemplary embodiment of the present invention;

FIGS. 9A9A, 10A, 11A, 12A and 13A are layout views of the TFT array panel shown in FIGS. 1 and 2 in intermediate steps of a manufacturing method thereof according to an exemplary embodiment of the present invention;

FIG. 9B is a sectional view of the TFT array panel shown in FIG. 9A taken along line IXB-IXB′;

FIG. 10B is a sectional view of the TFT array panel shown in FIG. 10A taken along line XB-XB′;

FIG. 11B is a sectional view of the TFT array panel shown in FIG. 11A taken along line XIB-XIB′;

FIG. 12B is a sectional view of the TFT array panel shown in FIG. 12A taken along line XIIB-XIIB′;

FIG. 13B is a sectional view of the TFT array panel shown in FIG. 13A taken along line XIIIB-XIIIB′;

FIG. 14 is a sectional view of a step of combining the TFT array panel and the color filter panel shown in FIGS. 13B and 8, respectively, in a manufacturing method according to an exemplary embodiment of the present invention;

FIG. 15 is a sectional view of a step of removing supporters from an LCD device in a manufacturing method according to an exemplary embodiment of the present invention;

FIG. 16 is a layout view of a TFT array panel for an LCD device according to another exemplary embodiment of the present invention;

FIG. 17 is a sectional view of the TFT array panel shown in FIG. 16 taken along lines XVII-XVII′ and XVII′-XVII″;

FIGS. 18 to 23 are sectional views of a TFT array panel for the LCD device in intermediate steps of a manufacturing method thereof according to another exemplary embodiment of the present invention;

FIG. 24 is a sectional view of a step of combining a TFT array panel and a color filter panel in a manufacturing method according to another exemplary embodiment of the present invention; and

FIG. 25 is a sectional view of a step of removing supporters from an LCD device in a manufacturing method according to another exemplary embodiment of the present invention.

### DETAILED DESCRIPTION OF THE INVENTION

The present invention will now be described more fully hereinafter with reference to the accompanying drawings, in which exemplary embodiments of the invention are shown. The present invention may, however, be embodied in many different forms and should not be construed as limited to the embodiments set forth herein.

In the drawings, the thickness of layers, films and regions are exaggerated for clarity. Like numerals refer to like elements throughout. It will be understood that when an element such as a layer, film, region or substrate is referred to as being “on” another element, it can be directly on the other element or intervening elements may also be present. In contrast, when an element is referred to as being “directly on” another element, there are no intervening elements present.

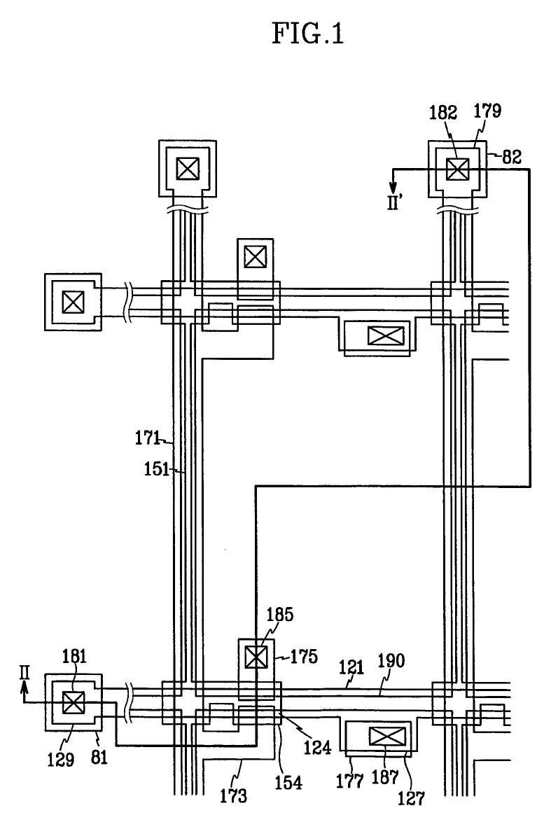

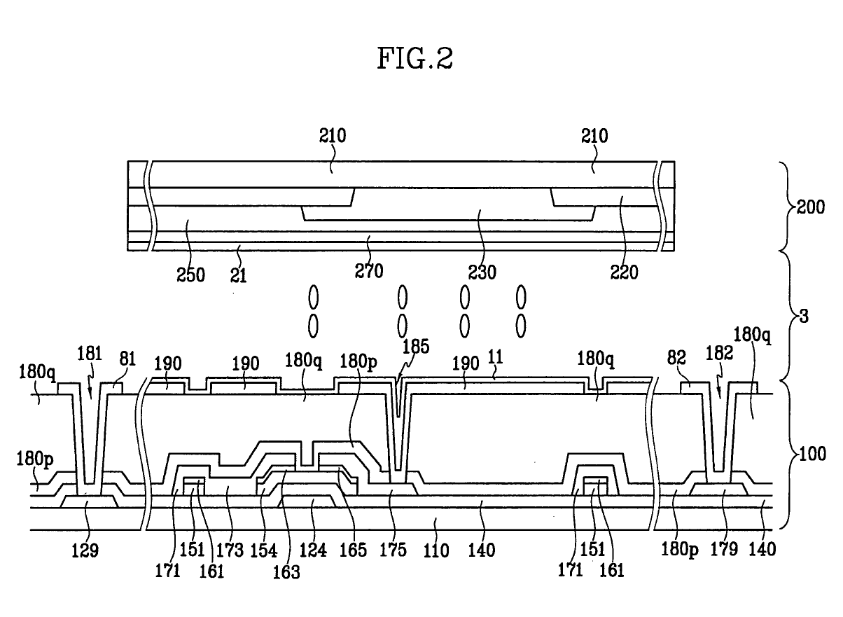

FIG. 1 is a layout view of a thin film transistor (TFT) array panel for a liquid crystal display (LCD) device according to an exemplary embodiment of the present invention, and FIG. 2 is a sectional view of the LCD device including the TFT array panel shown in FIG. 1 taken along line II-II′.

An LCD device according to an exemplary embodiment of the present invention includes a TFT array panel 100, a color filter panel 200, and a LC layer 3 interposed between the TFT array and color filter panels 100 and 200.

The color filter panel 200 will now be described in detail with reference FIG. 2. The color filter panel 200 includes a light blocking member 220 and an upper insulating substrate 210. The light blocking member 220 is also called a black matrix and prevents light leakage between pixels. The light blocking member 220 is formed on the upper insulating substrate 210, which may be, for example, a plastic substrate. The light blocking member 220 may include openings that face the pixels.

The upper insulating substrate 210 includes a layer made of one material selected from polyacrylate, polyethylene-terephthalate, polyethylene-naphthalate, polycarbonate, polyarylate, polyether-imide, polyehtersulfone, and polyimides. The upper insulating substrate 210 may further include a barrier layer of SiO₂, SiNₓ, which is disposed on both surfaces of the upper insulating substrate 210, and assists in preventing oxygen or moisture from penetrating into the upper insulating substrate 210 to maintain characteristics of color filters 230.

The color filters 230 are disposed on the upper insulating substrate 210. The color filters 230 are disposed substantially in areas enclosed by the light blocking member 220. The color filters 230 may extend substantially along a longitudinal direction along a pixel column. The color filters 230 may represent one of primary colors such as red, green and blue colors.

An overcoat 250 for preventing the color filters 230 from being exposed and for providing a flat surface is disposed on the color filters 230 and the light blocking member 220.

A common electrode 270, preferably made of transparent conductive material such as ITO and IZO, is disposed on the overcoat 250.

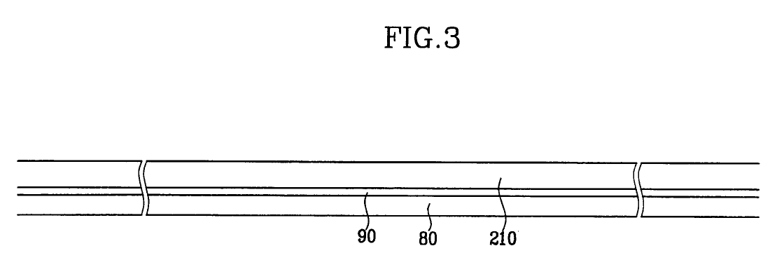

A method of manufacturing the color filter panel 200 for a flexible liquid crystal display according to exemplary embodiments of the present invention will be described with reference to FIGS. 3-8.

FIGS. 3 to 8 are sectional views of the color filter panel 200 for the LCD device in FIG. 2 in intermediate steps of a manufacturing method thereof according to an exemplary embodiment of the present invention.

Referring to FIG. 3, an upper insulating substrate 210 made of plastic is provided. The upper insulating substrate 210 includes a layer made of one material selected from polyacrylate, polyethylene-terephthalate, polyethylene-naphthalate, polycarbonate, polyarylate, polyether-imide, polyehtersulfone, and polyimlides. The upper insulating substrate 210 may further include a barrier layer of SiO₂, SiNₓ, which is formed on both surfaces of the upper insulating substrate 210, and assists in preventing oxygen or moisture from penetrating into the upper insulating substrate 210 to maintain the characteristics of the color filters 230.

Next, a first surface of an adhesion tape 90 having adhesive on the first surface and a second surface is adhered to a surface of the upper insulating substrate 210, and the second surface of the adhesion tape 90 is adhered to a surface of a glass supporter 80 to complete a combination of the upper insulating substrate 210 and the glass supporter 80. The glass supporter 80, the adhesion tape 90 and the upper insulating substrate 210 are arranged in sequence.

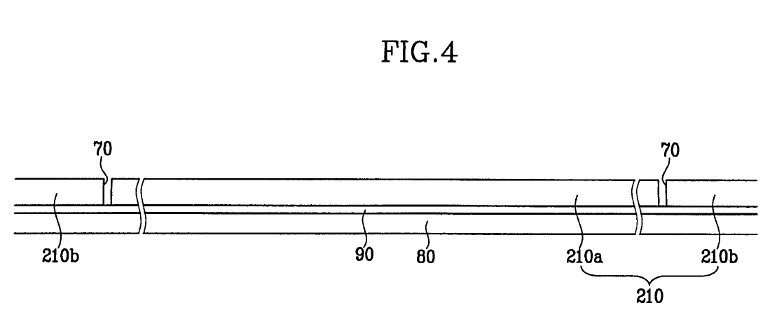

Referring to FIG. 4, half cutting using a cutter is executed to form a cutting portion 70. The half cutting means that the glass supporter 80 under the upper insulating substrate 210 is not cut and an entire thickness of the upper insulating substrate 210 is cut at selected portions of the upper insulating substrate 210. The upper insulating substrate 210 is divided into a first region 210a and a second region 210b by the half cutting. At this time, because the upper insulating substrate 210 is adhered to the glass supporter 80 by the adhesion tape 90, the first and second regions 210a and 210b may be removed from the glass supporter 80 after necessary processes are executed.

The first region 210a is an active region on which the light blocking member 220 and the color filter 230 are arranged. The second region 210b is a periphery region. The second region 210b faces a portion of the thin film array panel 100 exposed by the color filter panel 200. A driving circuit that may be integrated on the thin film transistor array panel 100, or a plurality of contact portions for contact with an external device may be arranged in the periphery region.

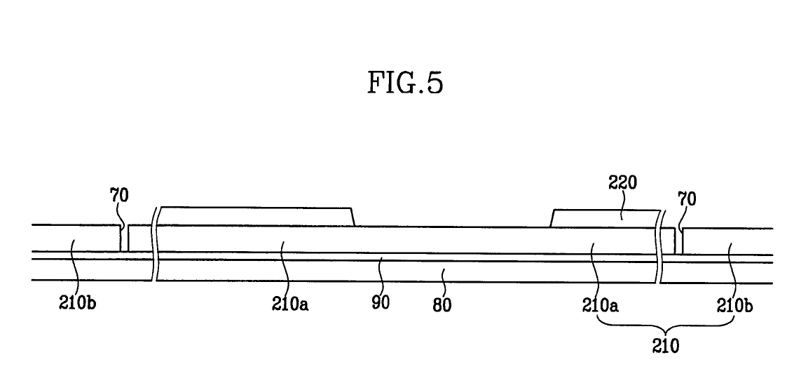

Referring to FIG. 5, the light blocking member 220 is formed by depositing an opaque material having good light-blocking characteristics such as, for example, oxidized steel, carbon black, and Cr, Ni, Fe or a metallic oxide thereof at an upper surface of the upper insulating substrate 210 and patterning the deposited opaque material through photolithography using a photo mask. It is preferable that a thickness of the light blocking member 220 is in a range of 2-4 microns.

In an example of a formation of the light blocking member 220, a photoresist, preferably made of negative photoresist, is coated by spin coating on a light blocking layer made of the opaque material and a portion of the photoresist is exposed to light having a wavelength range of 350-440 nm using the photo mask. Next, thermal treatment is executed in a range of about 110° C. for about 90 seconds, and an exposed portion of the photoresist is developed using 2.38 wt % TMAH (tetra methyl ammonium hydroxide) aqueous solution to form a photoresist pattern having a reversed taper structure. At this time, the exposed portion of the photoresist is allowed to remain as the photoresist pattern, and an unexposed portion of the photoresist is removed. Next, the light blocking layer is etched using the photoresist pattern as an etch mask to form the light blocking member 220.

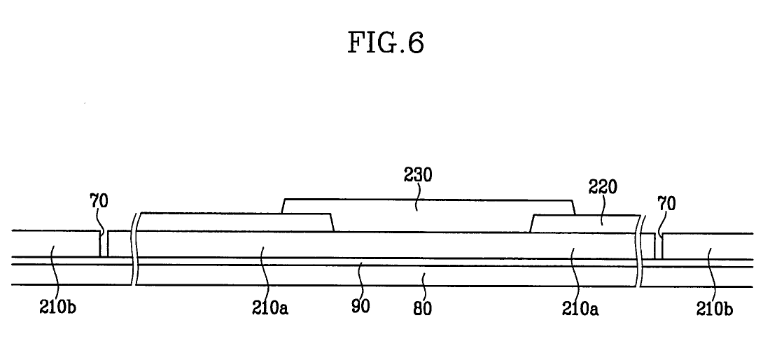

Referring to FIG. 6, the color filters 230 are disposed on the upper insulating substrate 210. The color filters 230 may be formed, for example, by sequentially coating, light-exposing, and developing negative photosensitive organic material containing red, green, and blue pigments. The color filters 230 having red, green, and blue colors are separated from each other and edge portions of each of the color filters 230 are extended to overlap edges of the light blocking member 220.

Next, a surface treatment involving irradiating ultraviolet rays or infrared rays is executed on surfaces of the color filters 230 and the light blocking member 220 to improve an adhesive strength between the color filters 230 and the light blocking member 220, and an overlying layer such as, for example, an ITO layer is deposited. The surface treatment using infrared rays is a pre-heating process before the surface treatment using ultraviolet rays, and remaining moisture and remaining gas in the color filters 230 are removed at this time. Furthermore, ozone with heavy density is injected into a chamber during the surface treatment using ultraviolet rays, and a molecule or atom of the injected ozone decomposes organic residue on the surfaces of the color filters 230 and the light blocking member 220.

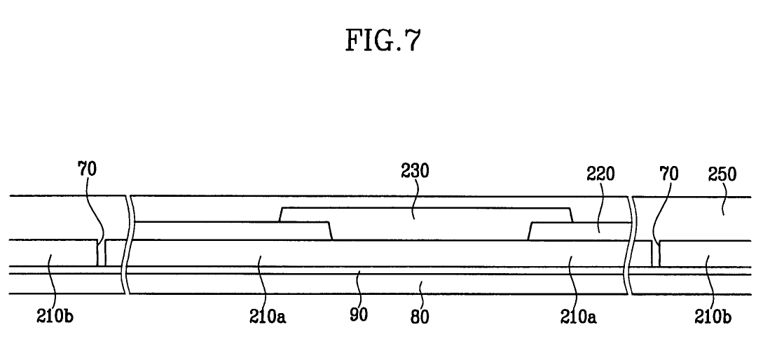

Referring to FIG. 7, an overcoat 250 preferably made of acryl material is disposed on the color filters 230 and the light blocking member 220 to enhance step coverage characteristics of the first overlying layer and a flatness of a surface of the color filter panel 200.

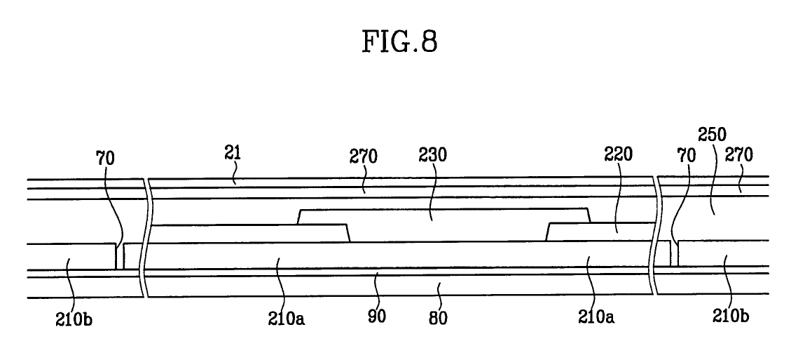

Subsequently, as shown in FIG. 8, an ITO or IZO layer is deposited on the overcoat 250 to form the common electrode 270, and an upper alignment layer 21 is coated thereon to form the color filter panel 200.

The thin film transistor array panel 100 will now be described in detail with reference FIGS. 1 and 2.

Gate lines 121 are disposed on a lower insulating substrate 110, which may be, for example, a plastic substrate. Like the upper insulating substrate 210, the lower insulating substrate includes a layer made of one material selected from polyacrylate, polyethylene-terephthalate, polyethylene-naphthalate, polycarbonate, polyarylate, polyether-imide, polyehtersulfone, and polyimides.

The lower insulating substrate 110 may further include a barrier layer of SiO₂, SiNₓ, which is disposed on both surfaces of the lower insulating substrate 110 and assists in preventing oxygen or moisture from penetrating into the lower insulating substrate 110 to maintain characteristics of an overlying layer.

The gate lines 121 extend substantially in a transverse direction. The gate lines are separated from each other and transmit gate signals. Each gate line 121 includes portions forming gate electrodes 124, projections 127 protruding downward and an end portion 129 having a large area for contact with another layer or an external driving circuit. The gate lines 121 may extend to be electrically connected to a driving circuit that may be integrated on the lower insulating substrate 110.

The gate lines 121 are preferably made of Al containing metal such as Al and Al alloy, Ag containing metal such as Ag and Ag alloy, Cu containing metal such as Cu and Cu alloy, Mo containing metal such as Mo and Mo alloy, Cr, Ti or Ta. The gate lines 121 may have a multi-layered structure including two films having different physical characteristics. One of the two films is preferably made of low resistivity metal including Al containing metal for reducing signal delay or voltage drop in the gate lines 121. The other of the two films is preferably made of material such as Cr, Mo and Mo alloy, Ta or Ti, which has good physical, chemical, and electrical contact characteristics with other materials such as indium tin oxide (ITO) or indium zinc oxide (IZO). Good examples of a combination of the two films include a lower Cr film and an upper Al (or Al—Nd alloy) film and a lower Al (or Al alloy) film and an upper Mo film.

In addition, the lateral sides of each of the gate lines 121 are tapered, and an inclination angle of the lateral sides with respect to a surface of the lower insulating substrate 110 ranges from about 30 degrees to about 80 degrees.

A gate insulating layer 140 preferably made of silicon nitride (SiNₓ) is disposed on the gate lines 121. Semiconductor stripes 151 preferably made of hydrogenated amorphous silicon (abbreviated to “a-Si”) or polysilicon are disposed on the gate insulating layer 140. Each semiconductor stripe 151 extends substantially in a longitudinal direction and has semiconductor projections 154 branched out toward the gate electrodes 124. A width of each of the semiconductor stripes 151 becomes large near the gate lines 121 such that each of the semiconductor stripes 151 covers large areas of the gate lines 121.

Ohmic contacts 161 and 165 preferably made of silicide or n+ hydrogenated a-Si heavily doped with n type impurity are disposed on the semiconductor stripes 151. The ohmic contacts 161 and 165 include ohmic contact stripes 161 and ohmic contact islands 165. Each ohmic contact stripe 161 has ohmic projections 163, and the ohmic projections 163 and the ohmic contact islands 165 are disposed in pairs on the semiconductor projections 154 of the semiconductor stripes 151.

The lateral sides of the semiconductor stripes 151 and the ohmic contacts 161 and 165 are tapered, and inclination angles of the ohmic contacts 161 and 165 are preferably in a range between about 30 degrees and about 80 degrees.

Data lines 171, drain electrodes 175 and storage capacitor conductors 177 are disposed on the ohmic contacts 161 and 165 and the gate insulating layer 140. The storage capacitor conductors 177 overlap the projections 127 of the gate lines 121.

The data lines 171 for transmitting data voltages extend substantially in the longitudinal direction and intersect the gate lines 121. Each of the data lines 171 includes an expansion 179 having a larger area for contact with another layer or an external device.

Branches of each data line 171, which project toward the drain electrodes 175, form source electrodes 173. Each pair of the source electrodes 173 and the drain electrodes 175 are separated from each other and opposite each other with respect to one of the gate electrodes 124. A gate electrode 124, a source electrode 173, and a drain electrode 175 along with a semiconductor projection 154 of a semiconductor stripe 151 form a TFT having a channel formed in the semiconductor projection 154 disposed between the source electrode 173 and the drain electrode 175.

The data lines 171 and the drain electrodes 175 are preferably made of refractory metal such as Cr, Mo, Ti, Ta or alloys thereof. However, the data lines 171 and the drain electrodes 175 may also have a multilayered structure including a low-resistivity film (not shown) and a good-contact film (not shown).

Like the gate lines 121, the data lines 171 and the drain electrodes 175 have tapered lateral sides, and inclination angles thereof range from about 30 degrees to about 80 degrees.

The ohmic contacts 161 and 165 are interposed between underlying semiconductor stripes 151 and overlying data lines 171 and overlying drain electrodes 175. The ohmic contacts 161 and 165 reduce a contact resistance between the underlying semiconductor stripes 151 and the overlying data lines 171 and the overlying drain electrodes 175. The semiconductor stripes 151 include exposed portions, which are not covered with the data lines 171 and the drain electrodes 175, such as portions located between the source electrodes 173 and the drain electrodes 175. Although the semiconductor stripes 151 are narrower than the data lines 171 at most places, a width of the semiconductor stripes 151 becomes large near the gate lines 121 as described above, to smooth a surface profile, thereby preventing disconnection of the data lines 171.

A lower passivation layer 180p preferably made of inorganic material such as silicon nitride or silicon oxide is disposed on the data lines 171, the drain electrodes 175, the storage electrode capacitors 177 and the exposed portions of the semiconductor stripes 151.

An upper passivation layer 180q is disposed on the lower passivation layer 180p. The upper passivation layer 180q is preferably made of photosensitive organic material having a good flatness characteristic, or low dielectric insulating material such as a-Si:C:O and a-Si:O:F formed by plasma enhanced chemical vapor deposition (PECVD). One of the lower and the upper passivation layers 180p and 180q may be omitted if necessary.

The upper and lower passivation layers 180q and 180p include a plurality of contact holes 182, 185 and 187 exposing the expansions 179 of the data lines 171, the drain electrodes 175, and the storage capacitor conductors 177, respectively. The upper and lower passivation layers 180q and 180p and the gate insulating layer 140 include contact holes 181 exposing end portions 129 of the gate lines 121.

Pixel electrodes 190 and contact assistants 81 and 82, which are preferably made of IZO or ITO, are disposed on the upper passivation layer 180q.

The pixel electrodes 190 are physically and electrically connected to the drain electrodes 175 through the contact holes 185 and to the storage capacitor conductors 177 through the contact holes 187 such that the pixel electrodes 190 receive the data voltages from the drain electrodes 175 and transmit received data voltages to the storage capacitor conductors 177.

The pixel electrodes 190 supplied with the data voltages generate electric fields in cooperation with the common electrode 270 on the color filter panel 200, which orients liquid crystal molecules in a liquid crystal layer 3 disposed between the TFT array and color filter panels 100 and 200.

A pixel electrode 190 and the common electrode 270 form a liquid crystal capacitor, which stores applied voltages after a turn-off of the TFT. An additional capacitor called a “storage capacitor,” which is electrically connected in parallel with the liquid crystal capacitor, is provided for enhancing a voltage storing capacity. The storage capacitor is implemented by overlapping the pixel electrode 190 with an adjacent gate line 121 (called a “previous gate line”). Capacitances of storage capacitors, i.e., storage capacitances, are increased by providing the projections 127 at the gate lines 121 for increasing overlapping areas and by providing the storage capacitor conductors 177, which are electrically connected to the pixel electrodes 190 and overlap the projections 127 under the pixel electrodes 190 for decreasing a distance between terminals. The pixel electrodes 190 optionally overlap the gate lines 121 and the data lines 171 to increase aperture ratio.

The contact assistants 81 and 82 are connected to the exposed end portions 129 of the gate lines 121 and the exposed expansions 179 of the data lines 171 through the contact holes 181 and 182, respectively. The contact assistants 81 and 82 are not requisites but preferred to protect the exposed portions 129 and the expansions 179 and to complement an adhesiveness of the exposed portion 129 and the expansions 179 to external devices.

The contact assistant 81 assists in connecting the end portions 129 of the gate lines 121 to a gate driving circuit when the gate driving circuit is integrated on the lower insulating substrate 110. The contact assistant 81 may be omitted.

According to another exemplary embodiment of the present invention, the pixel electrodes 190 are made of a transparent conductive polymer. For a reflective LCD device, the pixel electrodes 190 are made of an opaque reflective metal. In these cases, the contact assistants 81 and 82 may be made of a material such as IZO or ITO different from the pixel electrodes 190.

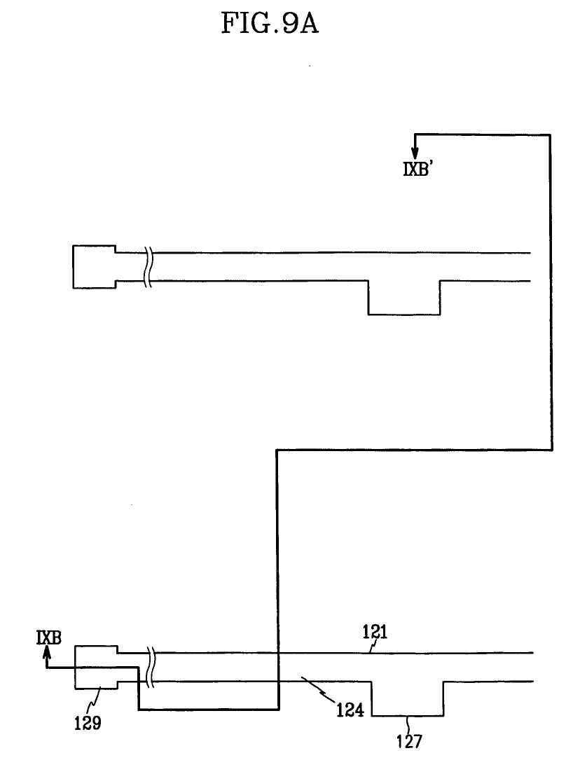

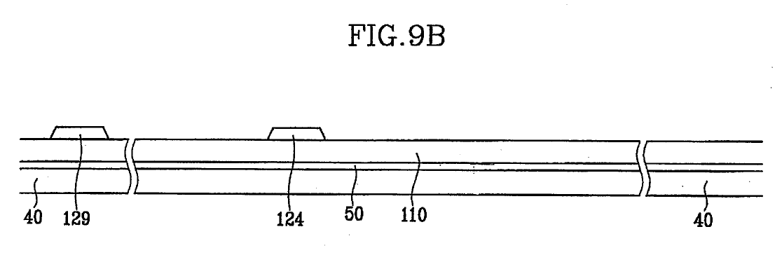

A method of manufacturing the TFT array panel shown in FIGS. 1 and 2 according to an exemplary embodiment of the present invention will be now described in detail with reference to FIGS. 9A to 13B.

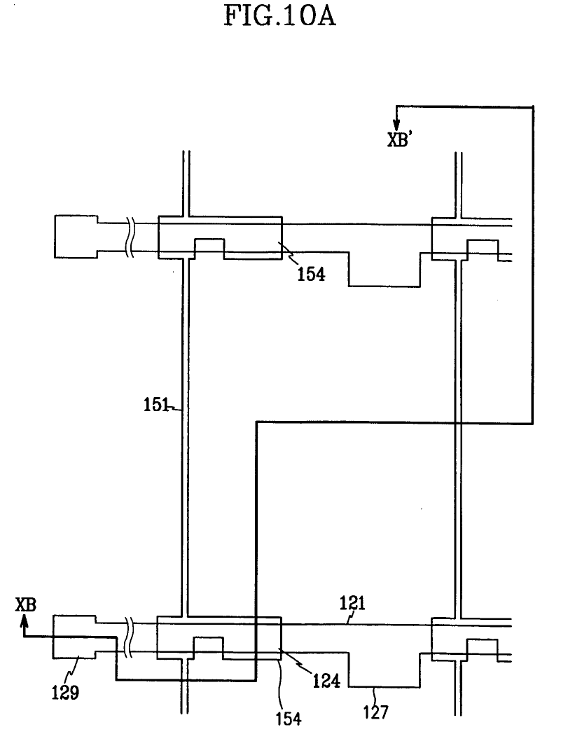

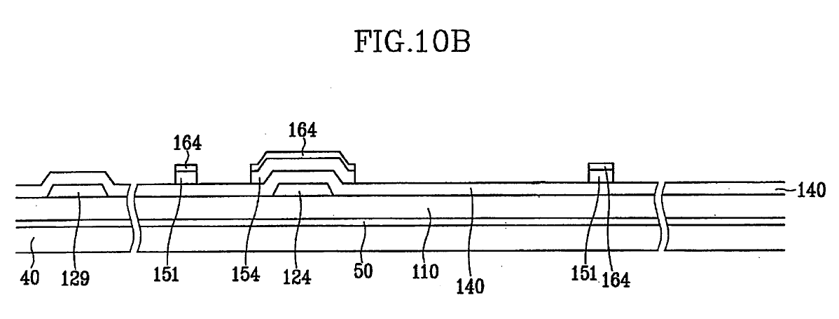

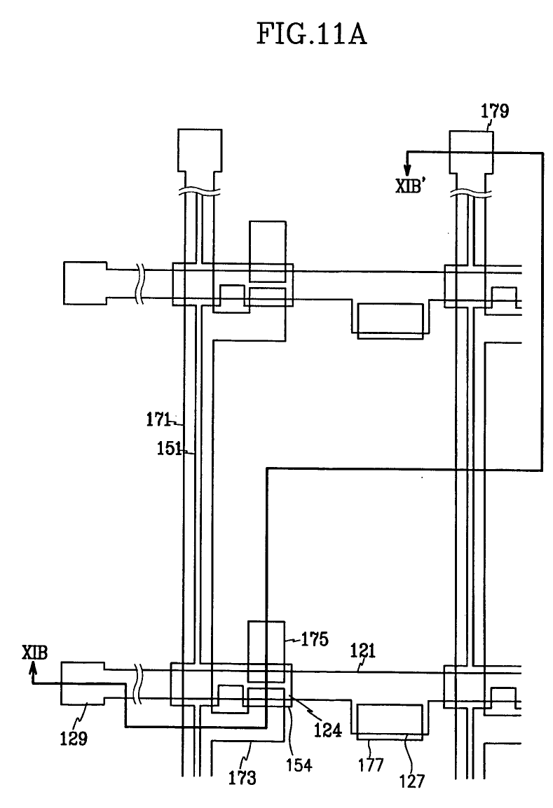

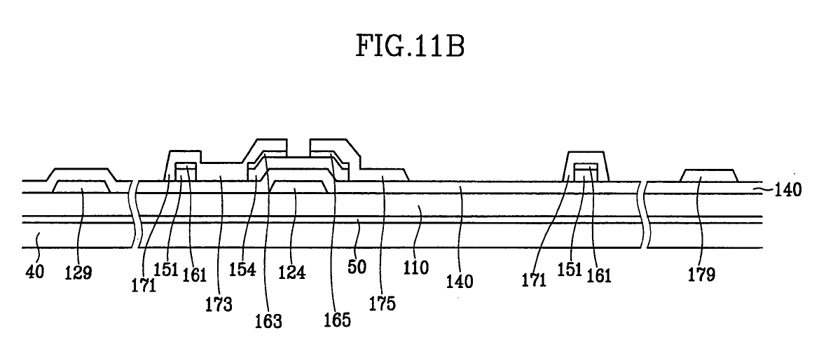

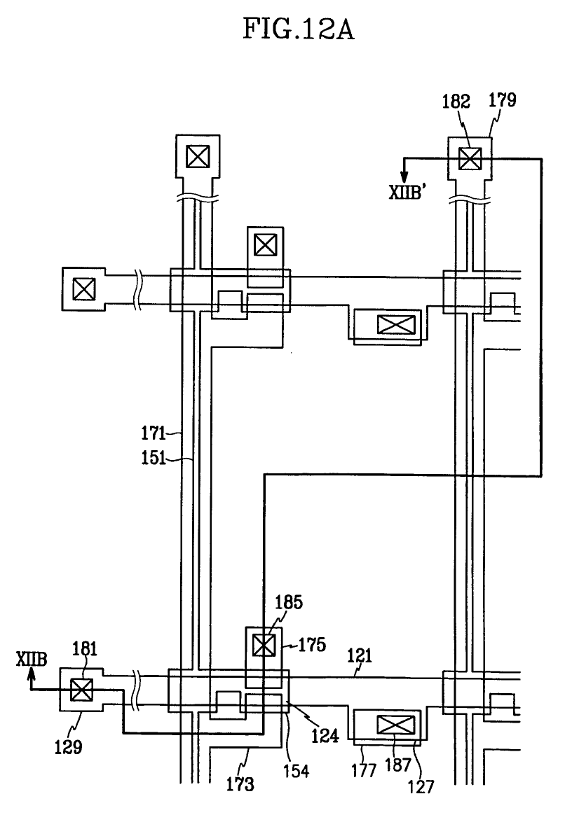

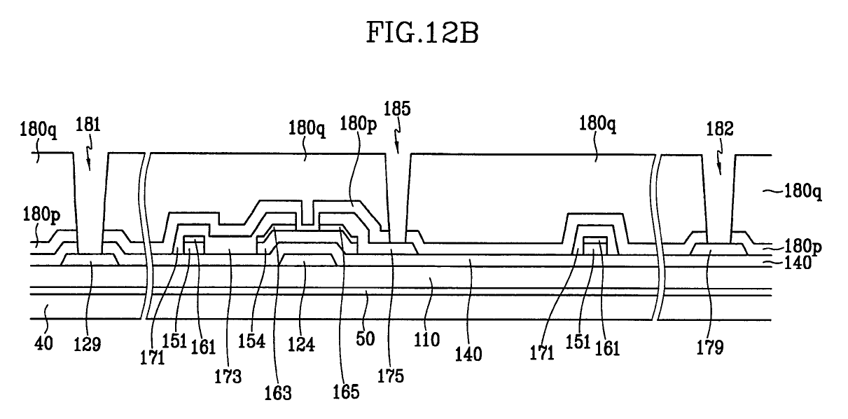

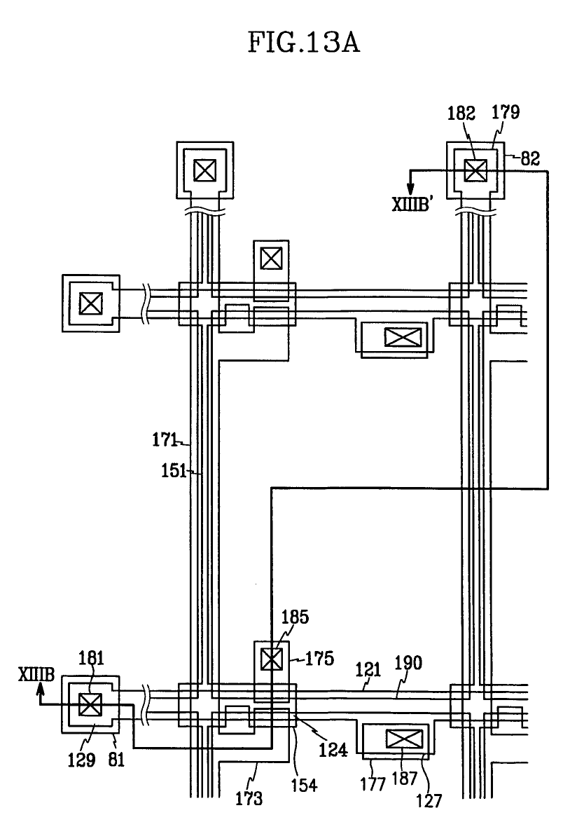

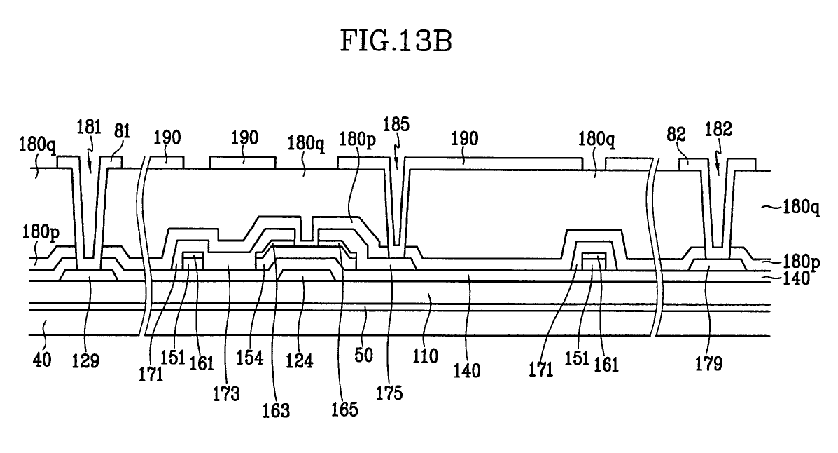

FIGS. 9A, 10A, 11A, 12A and 13A are layout views of the TFT array panel 100 shown in FIGS. 1 and 2 in intermediate steps of a manufacturing method thereof according to an exemplary embodiment of the present invention. FIG. 9B is a sectional view of the TFT array panel shown in FIG. 9A taken along line IXB-IXB′. FIG. 10B is a sectional view of the TFT array panel shown in FIG. 10A taken along line XB-XB′. FIG. 11B is a sectional view of the TFT array panel shown in FIG. 11A taken along line XIB-XIB′. FIG. 12B is a sectional view of the TFT array panel shown in FIG. 12A taken along line XIIB-XIIB′. FIG. 13B is a sectional view of the TFT array panel shown in FIG. 13A taken along line XIIIB-XIIIB′.

First, the lower insulating substrate 110 such as a plastic substrate is provided. The lower insulating substrate 110 includes a layer made of one material selected from polyacrylate, polyethylene-terephthalate, polyethylene-naphthalate, polycarbonate, polyarylate, polyether-imide, polyehtersulfone, and polyimides.

The lower insulating substrate 110 may further include a barrier layer of SiO₂, SiNₓ, which is disposed on both surfaces of the lower insulating substrate 110, and assists in preventing oxygen or moisture from penetrating into the lower insulating substrate 110 to maintain the characteristics of the overlying layer.

Next, a first surface of an adhesion tape 50 having adhesive disposed on the first surface and a second surface is adhered to a surface of the lower insulating substrate 110, and the second surface of the adhesion tape 50 is adhered to a surface of a glass supporter 40 to complete the combination of the lower insulating substrate 110 and the glass supporter 40.

As shown in FIGS. 9A and 9B, a metal film is sputtered and patterned by photo-etching with a photoresist pattern on the lower insulating substrate 110 to form gate lines 121 including gate electrodes 124, end portions 129 and projections 127.

Referring to FIGS. 10A and 10B, after sequential deposition of a gate insulating layer 140, an intrinsic a-Si layer, and an extrinsic a-Si layer, the extrinsic a-Si layer and the intrinsic a-Si layer are photo-etched to form extrinsic semiconductor stripes 164, ohmic contact stripes 161 and semiconductor stripes 151 including semiconductor projections 154 on the gate insulating layer 140.

Referring to FIGS. 11A and 11B, a metal film is sputtered and etched using a photoresist to form data lines 171 including source electrodes 173, drain electrodes 175, storage capacitor conductors 177, and expansions 179.

Before or after removing the photoresist, portions of the extrinsic semiconductor stripes 164, which are not covered with the data lines 171, the drain electrodes 175, and the storage capacitor conductors 177, are removed by etching to complete ohmic projections 163 and ohmic contact islands 165 and to expose portions of the semiconductor stripes 151. Oxygen plasma treatment may follow thereafter in order to stabilize exposed surfaces of the semiconductor stripes 151.

Referring to FIGS. 12A and 12B, a lower passivation layer 180p preferably made of inorganic material such as silicon nitride or silicon oxide is formed by plasma enhanced chemical vapor deposition (PECVD), and an upper passivation layer 180q preferably made of photosensitive organic material is coated on the lower passivation layer 180p. Then, the upper passivation layer 180q is exposed to light through a photo mask and developed to expose a portion of the lower passivation layer 180p, and the exposed portion of the lower passivation layer 180p is dry etched along with the gate insulating layer 140 to form a plurality of contact holes 181, 182, 185 and 187.

Referring to FIGS. 13A and 13B, a conductive layer preferably made of transparent material such as ITO, IZO and a-ITO (amorphous indium tin oxide) is deposited by sputtering and is etched using the photoresist to form pixel electrodes 190 and contact assistants 81 and 82. A process of forming a lower alignment layer 11 is also added.

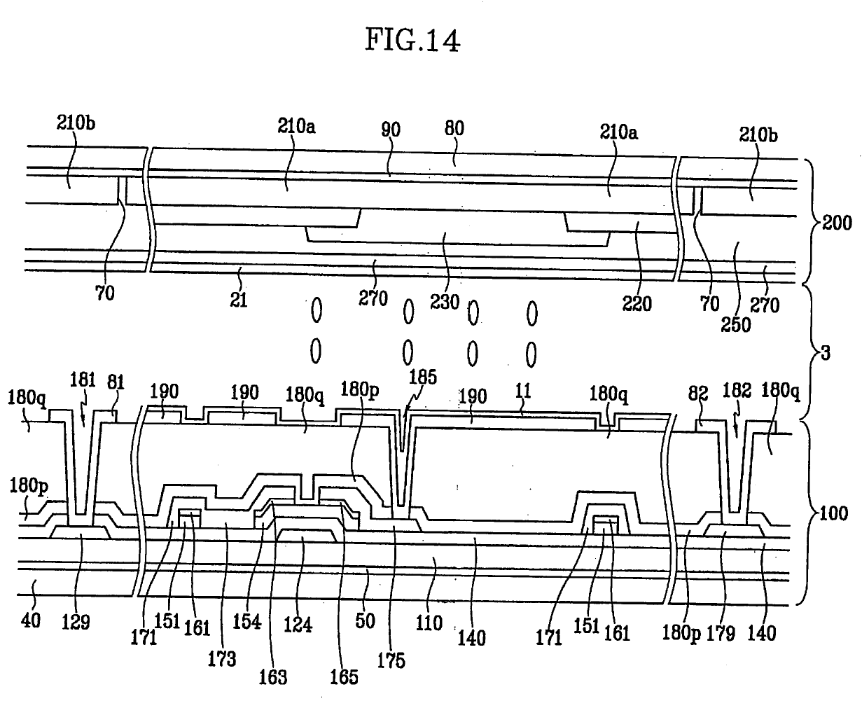

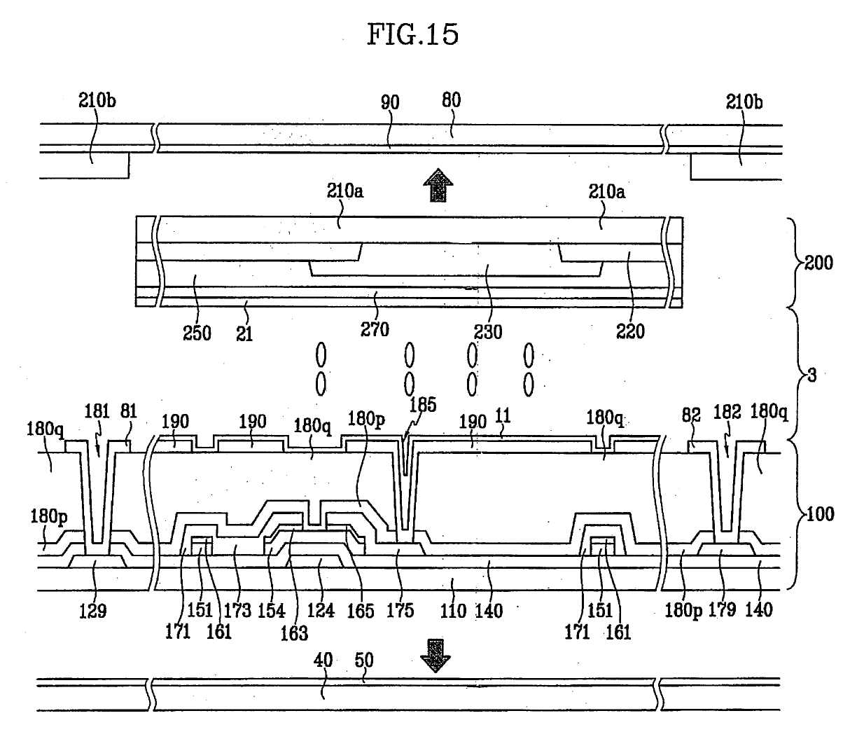

A method of manufacturing an LCD device according to an exemplary embodiment of the present invention will now be described in detail with reference to FIGS. 14 to 15.

FIG. 14 is a sectional view of a step of combining the TFT array panel 100 and the color filter panel 200 shown in FIGS. 13B and 8, respectively, in a manufacturing method according to an exemplary embodiment of the present invention. FIG. 15 is a sectional view of a step of removing supporters from the LCD device in a manufacturing method according to an exemplary embodiment of the present invention.

Referring to FIG. 14, an assembly process is executed to align the TFT array panel 100 shown in FIGS. 13A and 13B, and the color filter panel 200 shown in FIG. 8, which are manufactured as described above, and a hat press process is executed to combine the TFT array panel 100 and the color filter panel 200 at a temperature of about 150 degrees. In such a case, because the lower and upper substrates 110 and 210 are adhered to the glass supporters 40 and 80 by the adhesion tapes 50 and 90, transformations such as bending and expansion of the lower and upper insulating substrates 110 and 210 are not generated.

Next, a liquid formation process is executed to form the liquid crystal layer 3. The liquid formation process may be a drop type process in which a liquid crystal material is dropped on one of the TFT array and color filter panels 100 and 200 before the assembly process, or an injection type process in which a liquid crystal material is injected between the TFT array and color filter panels 100 and 200 using a capillary phenomenon and differences of pressure after the hat press process.

As shown in FIG. 14, the TFT array panel 100 and the color filter panel 200 face each other, the LC layer 3 is interposed between the TFT array and color filter panels 100 and 200, and the lower and upper alignment layers 11 and 21 are coated on inner surfaces of the TFT array and color filter panels 100 and 200.

Referring to FIG. 15, the glass supporters 40 and 80 are removed from the TFT array panel 100 and the color filter panel 200 of the LCD device by removing an adhesion strength of the adhesion tapes 50 and 90. The glass supporters 40 and 80 may be removed by, for example, adjusting a temperature, using a solvent to remove the adhesion strength, or irradiating the adhesion tapes 50 and 90 with ultraviolet rays etc. During temperature adjustment, the adhesion strength of the adhesion tapes 50 and 90 grows weaker when temperature decreases below about 0 degrees C. and the glass supporters 40 and 80 are removed from the TFT array panel 100 and the color filter panel 200 to form the LCD, respectively.

At this time, because the second region 210b is half-cut while manufacturing the color filter panel 200, the second region 210b is removed from the LCD device.

Accordingly, the periphery region of the TFT array panel 100, which had faced the second region 210b, is exposed by the color filter panel 200. Thus, driving portions that may be integrated on the TFT array panel 100, or contact portions for contact with an external device may be arranged on the TFT array panel 100.

As described above, the upper insulating substrate 210 for the color filter panel 200 is divided into the first and the second regions 210a and 210b through half cutting before assembling the color filter panel 200 and the TFT array panel 100, thereby removing the second region 210b of the color filter panel 200 without an additional process to expose the periphery region of the thin film array 100.

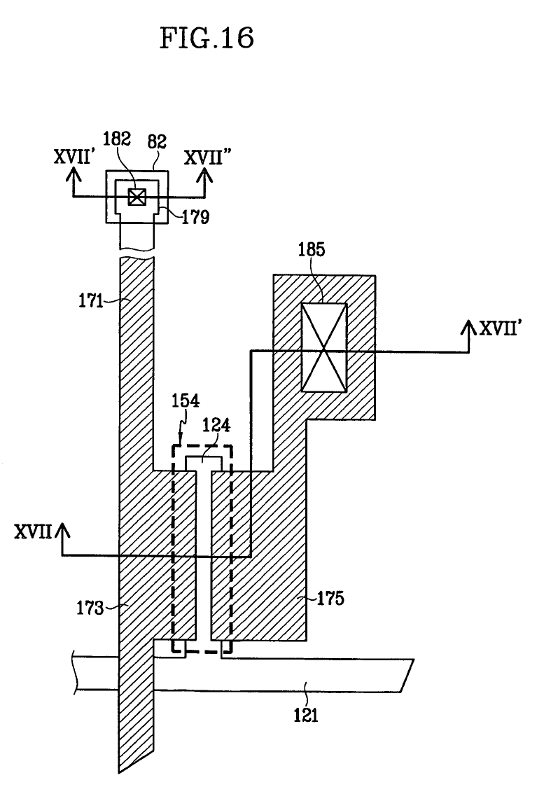

A method of manufacturing a flexible LCD device using a plastic substrate and an organic TFT according to an exemplary embodiment of the present invention will now be described in detail with reference to FIGS. 16 to 25.

Layered structures and manufacturing methods of the color filter panel 200 of the flexible LCD device according to this exemplary embodiment are same as those shown in FIGS. 2-8.

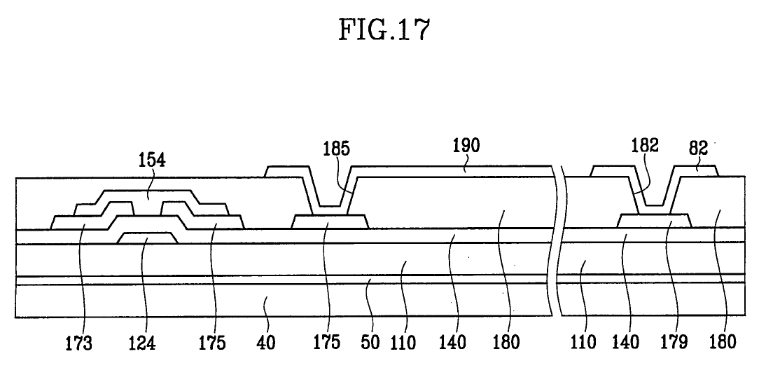

A TFT panel using organic semiconductor for the flexible LCD device according to this exemplary embodiment of the present invention will now be described in detail with reference to FIGS. 16 and 17.

FIG. 16 is a layout view of a TFT array panel for an LCD device according to another exemplary embodiment of the present invention, and FIG. 17 is a sectional view of the TFT array panel shown in FIG. 16 taken along lines XVII-XVII′ and XVII′-XVII″.

Gate lines 121 are disposed on a lower insulating substrate 110 such as a plastic substrate. The lower insulating substrate 110 includes a layer made of one material selected from polyacrylate, polyethylene-terephthalate, polyethylene-naphthalate, polycarbonate, polyarylate, polyether-imide, polyehtersulfone, and polyimides.

The lower insulating substrate 110 may further include a barrier layer of SiO₂, SiNₓ, which is disposed on both surfaces of the lower insulating substrate 110, and assists in preventing oxygen or moisture from penetrating into the lower insulating substrate 110 to maintain characteristics of an overlying layer.

A first surface of an adhesion tape 50 having adhesive on the first surface and a second surface is adhered to a surface of the lower insulating substrate 110, and the second surface of the adhesion tape 50 is adhered to a surface of a glass supporter 40. Thus the glass supporter 40, the adhesion tape 50 and the lower insulating substrate 110 are arranged in sequence.

The gate lines 121 extend substantially in a transverse direction to transmit gate signals. Each gate line 121 includes gate electrodes 124 protruding upward with respect to the lower insulating substrate 110. The gate lines 121 may have an end portion having a large area for contact with another layer or a driving circuit, and extend to be electrically connected to a driving circuit (not shown) that may be integrated on the lower insulating substrate 110.

The gate lines 121 are preferably made of Al containing metal such as Al and Al alloy, Ag containing metal such as Ag and Ag alloy, Cu containing metal such as Cu and Cu alloy, Au containing material such as Au and Au alloy, Mo containing metal such as Mo and Mo alloy, Cr, Ti or Ta. The gate lines 121 may have a multi-layered structure including two films having different physical characteristics. One of the two films is preferably made of low resistivity metal including Al containing metal, Ag containing metal, and Cu containing metal for reducing signal delay or voltage drop in the gate lines 121. The other of the two films is preferably made of material such as Mo containing metal, Cr, Ta or Ti, which has good physical, chemical, and electrical contact characteristics with other materials such as indium tin oxide (ITO) or indium zinc oxide (IZO). Good examples of a combination of the two films include a lower Cr film and an upper Al (alloy) film and a lower Al (alloy) film and an upper Mo (alloy) film. However, the gate lines 121 may be made of high molecule conductors.

A gate insulating layer 140 is disposed on the gate lines 121. The gate insulating layer 140 is preferably made of inorganic material such as silicon nitride (SiNₓ) and organic insulating material.

Data lines 171 and drain electrodes 175 are disposed on the gate insulating layer 140. The data lines 171 extend substantially in a longitudinal direction to transmit data voltages and intersect the gate lines 121. Each of the data lines 171 includes an end portion or expansion 179 having a large area for contact with another layer or an external device. Each of the data lines 171 includes source electrodes 173 projecting toward the gate electrodes 124. Each pair of the source electrodes 173 and the drain electrodes 175 are separated from each other and disposed opposite each other with respect to one of the gate electrodes 124.

The data lines 171 preferably include a conductive material made of Al containing metal such as Al and Al alloy, Ag containing metal such as Ag and Ag alloy, and another conductive layer made of Mo, Cr, Ti, Ta or an alloy thereof is added. Thus the data lines 171 may have a multi-layered structure. Furthermore, the data lines 171 and the drain electrodes 175 may be made of high molecule conductors.

Organic semiconductor islands 154 are disposed on the source electrodes 173, the drain electrodes 175 and the gate insulating layer 140. The organic semiconductor islands 154 fully cover the gate electrodes 124 such that edges of the gate electrodes 124 overlap the organic semiconductor islands 154.

The organic semiconductor islands 154 may be made of low molecule compounds such as oligothiophene, pentacene, phthalocyanine, and C6O, or high molecule compounds such as polythiophene and polythienylenevinylene.

The organic semiconductor islands 154 may include a high molecular compound or a low molecular compound that is soluble in an aqueous solution or an organic solvent. Usually, high molecular organic semiconductor is very soluble in solvent and thus suitable for printing.

A gate electrode 124, a source electrode 173, and a drain electrode 175 along with a semiconductor island 154 form a TFT having a channel formed by the semiconductor island 154 disposed between the source electrode 173 and the drain electrode 175.

A passivation layer 180 is formed on the data lines 171, the drain electrodes 175, and the organic semiconductor islands 154. The passivation layer 180 is preferably made of inorganic insulator such as silicon nitride or silicon oxide, organic insulator, or a low dielectric insulating material. The low dielectric insulating material preferably has a dielectric constant lower than 4.0 and examples thereof are a-Si:C:O and a-Si:O:F formed by plasma enhanced chemical vapor deposition (PECVD). The organic insulator may have photosensitivity and the passivation layer 180 may have a flat surface. The passivation layer 180 includes contact holes 182 and 185 exposing expansions 179 of the data lines 171 and the drain electrodes 175, respectively.

Pixel electrodes 190 are disposed on the passivation layer 180, and contact assistants 82 are disposed in the contact holes 182. The pixel electrodes 190 and the contact assistants 82 are preferably made of transparent conductor such as ITO or IZO.

The pixel electrodes 190 are physically and electrically connected to the drain electrodes 175 through the contact holes 185 such that the pixel electrodes 190 receive the data voltages from the drain electrodes 175. The pixel electrodes 190 supplied with the data voltages generate electric fields in cooperation with a common electrode (not shown) disposed opposite the pixel electrodes 190 and supplied with a common voltage. The electric fields generated by the pixel electrodes 190 and the common electrode determine orientations of liquid crystal molecules of a liquid crystal layer (not shown) disposed between the two electrodes.

The contact assistants 82 are connected to exposed end portions or expansions 179 of the data lines 171 through the contact holes 182, respectively. The contact assistants 82 protect the expansions 179 and complement the adhesiveness of the expansions 179 to external devices.

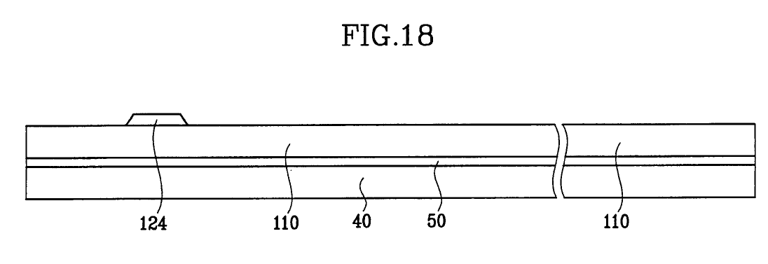

A method of manufacturing the TFT array panel shown in FIGS. 16-17 according to an exemplary embodiment of the present invention will now be described in detail with reference to FIGS. 18-23 as well as FIGS. 16 and 17.

FIGS. 18 to 23 are sectional views of the TFT array panel for the LCD device in intermediate steps of a manufacturing method thereof according to another exemplary embodiment of the present invention.

Referring to FIG. 18, a lower insulating substrate 110, preferably made of plastic, is adhered to a surface of a glass supporter 40 preferably made of transparent glass using a adhesion tape 50 preferably made of polyimide. A metal film is then sputtered and patterned by photo-etching with a photoresist pattern on the lower insulating substrate 110 to form gate lines 121 including gate electrodes 124.

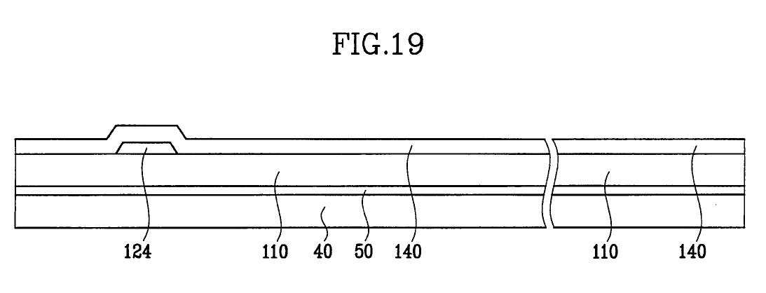

Referring to FIG. 19, a gate insulating layer 140 covering the gate electrode 124 is deposited by CVD. The gate insulating layer 140 may be made of an inorganic material such as silicon oxide and silicon nitride, or an organic material.

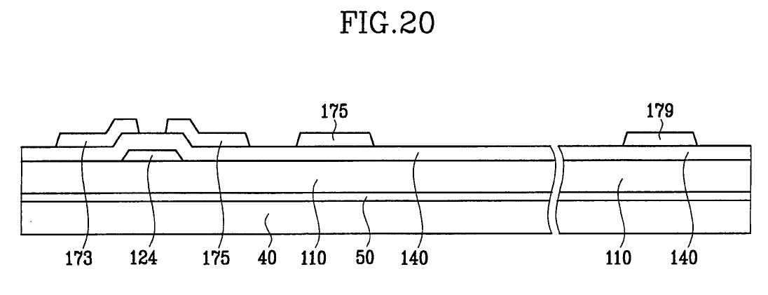

Referring to FIG. 20, data lines 171 including source electrodes 173 and end portion or expansion 179 and drain electrodes 175 are disposed on the gate insulating layer 140. To form the data lines 171 and the drain electrodes 175, a conductive layer preferably made of low resistivity metal such as Au is deposited by vacuum heat deposition, or a high molecule conductive layer is coated by slit coating, and the high molecule conductive layer is patterned by lithography and etched

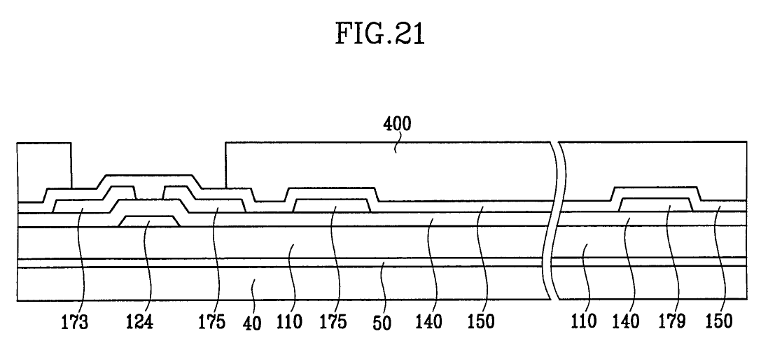

Referring to FIG. 21, an organic semiconductor layer 150, preferably made of a high molecular compound or a low molecular compound that is soluble in an aqueous solution or an organic solvent, is coated on the gate insulating layer 140.

Thereafter, a photoresist film is coated on the organic semiconductor layer 150 by slit coating and subjected to light exposure and development to form a photoresist 400 defining a semiconductor region.

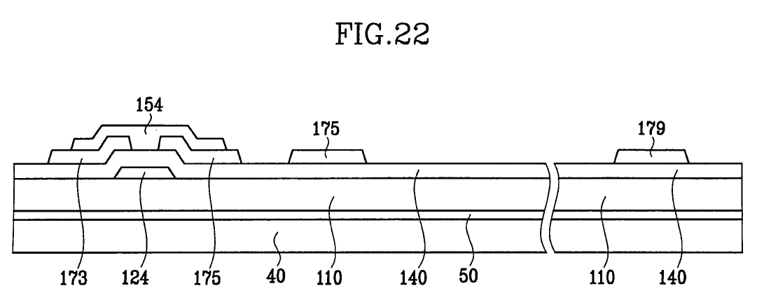

Referring to FIG. 22, the organic semiconductor layer 150 is etched by using the photoresist 400 as an etch mask to form organic semiconductor islands 154 disposed to cover a channel between the source electrodes 173 and the drain electrodes 175 and portions of both the source and drain electrodes 173 and 175.

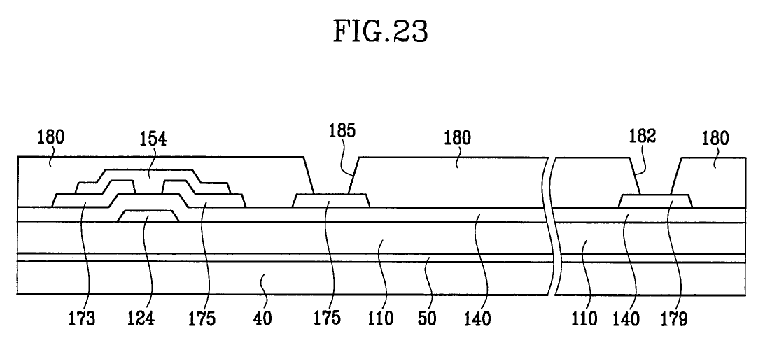

Referring to FIG. 23, a passivation layer 180 preferably made of an inorganic material such as silicon nitride, or an organic material having a low dielectric constant is deposited and patterned along with the gate insulating layer 140 to form contact holes 182 and 185 exposing the expansions 179 of the data lines 171, and portions of the drain electrodes 175, respectively.

Referring to FIG. 17, pixel electrodes 190 and contact assistants 82 are disposed on the passivation layer 180. To form the pixel electrodes 190 and the contact assistants 82, an IZO layer is sputtered at a temperature below about 250 degrees C. to minimize contact resistance.

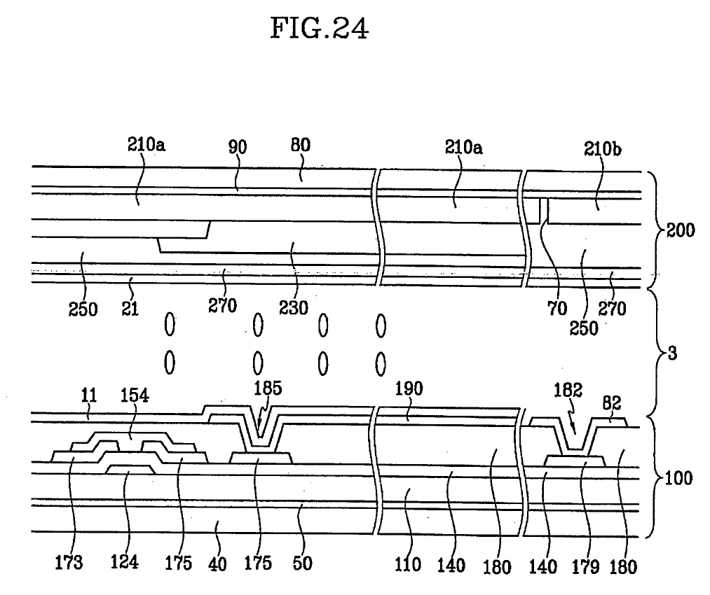

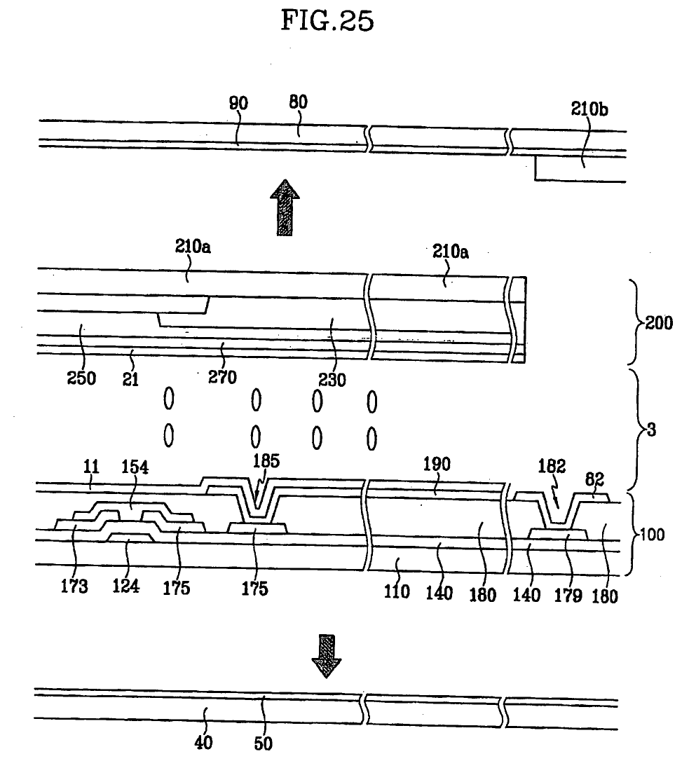

A method of manufacturing an LCD device according to another exemplary embodiment of the present invention will now be described in detail with reference to FIGS. 24 and 25.

FIG. 24 is a sectional view of a step of combining the TFT array panel 100 and the color filter panel 200 shown in FIGS. 23 and 8, respectively, in a manufacturing method of an LCD device according to another exemplary embodiment of the present invention. FIG. 25 is a sectional view of a step of removing supporters from the LCD device according to another exemplary embodiment of the present invention.

Referring to FIG. 24, an assembly process is executed to align the TFT array panel 100 shown in FIG. 23, and the color filter panel 200 shown in FIG. 8, which are manufactured through the above descriptions, and a hat press process is executed to combine the TFT array panel 100 and the color filter panel 200 at a temperature of about 150 degrees C. In this case, because the lower and upper insulating substrates 110 and 120 are adhered to the glass supporters 40 and 80 by the adhesion tapes 50 and 90, transformations such as bending and expansion of the lower and upper insulating substrates 110 and 120 are not generated.

Next, a liquid formation process is executed to form the liquid crystal layer 3. The liquid formation process may be a drop type process in which a liquid crystal material is dropped on one of the TFT array and color filter panels 100 and 200 before the assembly process, or a injection type process in which a liquid crystal material is injected between the TFT array and color filter panels 100 and 200 by using a capillary phenomenon and differences of pressure after the hat press process.

As shown in FIG. 24, the TFT array panel 100 and the color filter panel 200 face each other, the LC layer 3 is interposed between the TFT array and color filter panels 100 and 200, and the lower and upper alignment layers 11 and 21 are coated on inner surfaces of the TFT array and color filter panels 100 and 200.

Referring to FIG. 25, the glass supporters 40 and 80 are removed from the TFT array panel 100 and the color filter panel 200 of the LCD device by removing the adhesion strength of the adhesion tapes 50 and 90. To remove the glass supporters 40 and 80, methods including adjusting temperature, using a solvent to remove the adhesion strength or irradiating the adhesion tapes 50 and 90 with ultraviolet rays etc. are provided. During temperature adjustment, the adhesion strength of the adhesion tapes 50 and 90 grows weaker in temperatures less than about 0 degrees C., and the glass supporters 40 and 80 are removed from the TFT array panel 100 and the color filter panel 200, respectively, to form the LCD device.

At this time, because the second region 210b is half-cut while manufacturing the color filter panel 200, the second region 210b is removed from the LCD.

Accordingly, the periphery region of the TFT array panel 100, which had faced the second region 210b, is exposed by the color filter panel 200. Thus, driving portions that may be integrated on the TFT array panel 100, or contact portions for contact with an external device may be arranged on the TFT array panel 100.

As described above, the upper insulating substrate 210 for the color filter panel 200 is divided into the first and the second regions 210a and 210b through half cutting before assembling the color filter panel 200 and the TFT array panel 100, thereby removing the second region 210b of the color filter panel 200 without an additional process to expose the periphery region of the thin film array 100.

As above described, a predetermined region of the color filter panel 200 is half-cut before assembling the color filter panel 200 and the TFT array panel 200, thereby allowing easy removal of the predetermined region of the color filter panel 200, which faced the driving portion or contact portion of the TFT array panel 100, without an additional process.

While the present invention has been described in detail with reference to exemplary embodiments, those skilled in the art will appreciate that various modifications and substitutions can be made thereto without departing from the spirit and scope of the present invention as set forth in the appended claims.

What is claimed is:

1. A method of manufacturing a flexible display device, the method comprising:
adhering a first substrate to a supporter;
half cutting the first substrate to divide the first substrate into a first region and a second region;
assembling the first substrate and a second substrate facing the first substrate;
combining the first and second substrates; and
removing the second region of the first substrate from the first region of the first substrate.

2. The method of claim 1, wherein the first substrate includes plastic.

3. The method of claim 1, further comprising:
disposing a light blocking member on the first substrate;
disposing a color filter on the light blocking member; and
disposing a common electrode on the color filter.

4. The method of claim 1, wherein prior to removal of the second region, the second region of the first substrate faces a driving portion of the second substrate.

5. The method of claim 1, wherein the adhering the first substrate to the supporter includes applying an adhesive to adjacent surfaces of the first substrate and the supporter.

6. The method of claim 5, wherein the removing the second region of the first substrate from the first region of the first substrate includes removing an adhesion strength of the adhesive.

7. The method of claim 1, wherein the supporter comprises glass.

8. The method of claim 1, wherein the removing the second region of the first substrate from the first region of the first substrate includes adjusting a temperature to enable removal of the second region.

9. The method of claim 8, wherein the adjusting the temperature comprises decreasing the temperature to below about 0° C.

10. The method of claim 1, wherein the removing the second region of the first substrate from the first region of the first substrate includes irradiating an adhesive between the first substrate and the supporter with ultraviolet rays to enable removal of the second region.

11. The method of claim 1, further comprising:
disposing a gate line on a portion of the second substrate;
disposing a gate insulating layer on the gate line and remaining portions of the second substrate;
disposing a semiconductor on selected portions of the gate insulating layer;
disposing a data line including a source electrode and a drain electrode on a portion of the gate insulating layer; and
disposing a pixel electrode connected to the drain electrode.

12. The method of claim 1, further comprising:
disposing a gate line on a portion of the second substrate;
disposing a gate insulating layer on the gate line and remaining portions of the second substrate;
disposing a source electrode and a drain electrode on selected portions of the gate insulating layer;
disposing an organic semiconductor on the source and the drain electrodes; and
disposing a pixel electrode connected to the drain electrode.

13. The method of claim 1, wherein the combining the first and the second substrates includes performing a hot press process.

14. The method of claim 1, wherein the half cutting the first substrate comprises cutting through an entire thickness of the first substrate at selected portions of the first substrate and not cutting any portion of the supporter.

15. A method of manufacturing a flexible display device, the method comprising:
adhering a first substrate to a supporter;
cutting through an entire thickness of the first substrate at selected portions of the first substrate defining an active region of the flexible display and not cutting through any part of the supporter;
combining the first substrate and a second substrate; and
removing the supporter and portions of the first substrate not including the active region.

16. The method of claim 15, wherein the adhering the first substrate to the supporter includes applying an adhesive to adjacent surfaces of the first substrate and the supporter.

17. The method of claim 16, wherein the removing the supporter and the portions of the first substrate not including the active region includes removing an adhesion strength of the adhesive at portions of the first substrate corresponding to the active region.

18. The method of claim 17, wherein the removing the adhesion strength of the adhesive comprises one of:
irradiating the adhesive with ultraviolet rays;
exposing the adhesive to a solvent; and
reducing a temperature of the adhesive below about 0° C.

19. The method of claim 15, further comprising:
disposing a gate line on a portion of the second substrate;
disposing a gate insulating layer on the gate line and remaining portions of the second substrate;
disposing a semiconductor on selected portions of the gate insulating layer;
disposing a data line including a source electrode and a drain electrode on a portion of the gate insulating layer; and
disposing a pixel electrode connected to the drain electrode.

20. The method of claim 15, further comprising:
disposing a gate line on a portion of the second substrate;
disposing a gate insulating layer on the gate line and remaining portions of the second substrate;
disposing a source electrode and a drain electrode on selected portions of the gate insulating layer;
disposing an organic semiconductor on the source and the drain electrodes; and
disposing a pixel electrode connected to the drain electrode.
